(19) United States
(12) Patent Application Publication
(10) Pub. No.: US 2026/0357461 A1
(43) Pub. Date: Nov. 12, 2026

(54) A METHOD OF COMPRESSING A WATER-CONTAINING OXYGEN-CONTAINING STREAM

(71) Applicant: SHELL USA, INC., Houston, TX (US)

(72) Inventors: Marianna Kaloutsi, Amsterdam (NL); Namrata Shah, Amsterdam (NL); Paul WILLIAMS, London (GB)

(21) Appl. No.: 19/122,895

(22) PCT Filed: Nov. 21, 2023
(86) PCT No.: PCT/EP2023/082492

§ 371 Date: Apr. 21, 2025

(30) Foreign Application Priority Data
Nov. 24, 2022 (EP) 22386084.2

(51) Int. Cl. C25B 15/08; C25B 1/04

(52) U.S. Cl. CPC C25B 15/083; C25B 1/04; C25B 15/081

(57) ABSTRACT

A method of compressing a water-containing oxygen-containing stream originating from an electrolyzer, the method at least includes:
(a) providing a water-containing oxygen-containing stream (10);
(b) combining the stream (10) as a suction fluid in an ejector (2) with a water-containing stream (20) as a motive fluid, obtaining a combined stream;
(c) flashing the combined stream, obtaining a two-phase fluid (30) discharged from the ejector (2);
(d) separating the two-phase fluid (30) into an oxygen-containing gas stream (40) and a liquid stream (50);
(e) pressurizing the liquid stream (50), obtaining a pressurized liquid stream;
(f) using the pressurized liquid stream as the motive fluid (20) in step (b);
(g) dehydrogenating the stream (40), obtaining a dehydrogenated oxygen-containing stream (70);
(h) dehydrating the stream (70), obtaining a dehydrated dehydrogenated oxygen-containing stream (80);
(i) compressing the stream (80), obtaining a compressed oxygen-containing stream (90); and
(j) using the stream (90).

The present invention relates to a method of compressing a water-containing oxygen-containing stream originating from an electrolyzer, wherein the obtained compressed oxygen-containing stream is used, in particular in a gasifier.

Compression of gaseous streams is well known in the art. Typically, the compression of gaseous streams is achieved by positive displacement devices such as reciprocating or screw compressors which reduce the volume that the gas occupies and hence increase the pressure. This kind of ‘dry’ compression can also be achieved by centrifugal blowers, compressors or pumps, which use impellers to accelerate the gas and then decelerate the gas converting the kinetic energy of the gas to pressure. Usually, to achieve the desired pressure increase, multiple stages of compression and cooling between the stages is required.

A problem of multi-stage compressors is that they are typically associated with high capital costs due to associated equipment, installation and high operation costs.

A further problem of conventional ‘dry’ compression is that it cannot be used for compressing water-saturated oxygen-containing streams as for example originating from an electrolyzer. Conventional compressors cannot tolerate any water in an oxygen-containing stream and the use of such compressors for oxygen-containing streams originating from an electrolyzer would result in a safety risk. This, as hydrogen and oxygen present in the oxygen-containing streams originating from an electrolyzer may form an explosive mixture; this issue is even more significant in case the oxygen-containing stream is subsequently to be used in a gasifier. Further, the presence of water may lead to corrosion of the compressor/pipes. If this leads to any dust particles in the system and, as a result of compression, the temperature of the gas mixture increases, it could lead to a kindling chain reaction leading to possible fire or explosion. It may be possible to avoid this through the selection of special alloy materials, but this would entail excessive cost.

It is an object of the present invention to solve, minimize or at least reduce one or more of the above problems.

It is a further object of the present invention to provide an alternative process for compressing a water-containing, in particular a water-saturated, oxygen-containing stream originating from an electrolyzer, wherein the obtained compressed oxygen-containing stream is used, in particular in a gasifier.

One or more of the above or other objects may be achieved according to the present invention by providing a method of compressing a water-containing oxygen-containing stream originating from an electrolyzer, the method at least comprising the steps of:
(a) providing a water-containing oxygen-containing stream;
(b) combining the water-containing oxygen-containing stream provided in step (a) as a suction fluid in an ejector with a water-containing stream as a motive fluid, thereby obtaining a combined stream;
(c) flashing the combined stream by the ejector, thereby obtaining a two-phase fluid discharged from the ejector;
(d) separating the two-phase fluid discharged from the ejector into an oxygen-containing gas stream and a liquid stream;
(e) pressurizing the liquid stream obtained in step (d), thereby obtaining a pressurized liquid stream;
(f) using the pressurized liquid stream obtained in step (e) as the motive fluid in step (b);
(g) dehydrogenating the oxygen-containing gas stream obtained in step (d), thereby obtaining a dehydrogenated oxygen-containing stream;
(h) dehydrating the dehydrogenated oxygen-containing stream obtained in step (g), thereby obtaining a dehydrated dehydrogenated oxygen-containing stream;
(i) compressing the dehydrated dehydrogenated oxygen-containing stream obtained in step (h) thereby obtaining a compressed oxygen-containing stream; and
(j) using the compressed oxygen-containing stream obtained in step (i), in particular in a gasifier.

It has surprisingly been found according to the present invention that by using the water-containing (preferably water-saturated) oxygen-containing stream originating from an electrolyzer as a suction fluid in an ejector, a pressurized oxygen-containing gas stream can be obtained in a surprisingly simple manner, without the safety issues as confronted in ‘dry compression’.

A further advantage of the process according to the present invention is that a static piece of equipment can be used to achieve pressure transfer. Such a static piece of equipment is reliable, simple and requires less expensive construction materials. Ejectors are considered static equipment and are generally associated with low capital and operating costs in comparison to compressors. The ejector converts the pressure energy available in the motive fluid to velocity energy, brings in the (lower pressure) suction fluid, mixes the two fluids and discharges the mixture at an intermediate pressure without the use of rotating or moving parts.

In this respect it is noted that ejectors are known per se for decades, but have not been suggested for the use of compressing a water-containing oxygen-containing streams originating from an electrolyzer, wherein the compressed oxygen-containing stream is used as a product in e.g. a gasifier.

As a mere recent example, WO 2022/069906 A1 discloses the use of an ejector for condensing in particular CO₂. Although WO 2022/069906 A1 suggests (see page 4, lines 8-11) various fluids (i.e. water, methane, ethane, propane, ethylene, propylene, methanol, ethanol, acetone, nitrous oxide) to be used as motive fluid and gas to be compressed, no mention of an oxygen-containing stream (typically also comprising hydrogen) originating from an electrolyzer to be used as a suction fluid in an ejector has been made.

As a further example where an ejector is used, JP2003105577A discloses a fuel cell hybrid system comprising a gas generating section (using electrolysis of water) for producing hydrogen and oxygen and a fuel cell section for generating electricity by using the hydrogen and/or oxygen as generated in the gas generating section in the fuel cell section.

Further, WO 2020/035470 A1 discloses a gas power cycle for power generation where use is made of an ejector. There is no mention in WO 2020/035470 A1 that a water-containing oxygen-containing stream is originating from an electrolyzer.

In step (a) of the method according to the present invention, a water-containing oxygen-containing stream is provided.

The water-containing oxygen-containing stream provided in step (a) is not limited in any way (in terms of composition, temperature, pressure, etc.), as long as it contains oxygen (O₂) and water (H₂O) and as long as it is originating from an electrolyzer.

Typically and preferably, the water-containing oxygen-containing stream provided in step (a) is a gaseous stream, and it preferably is a water-saturated stream. It may even contain some liquid water carryover (up to 1.0 vol. %).

Preferably, the water-containing oxygen-containing stream provided in step (a) comprises at least 80 mol % O₂, preferably at least 90 mol % O₂, more preferably at least 95 mol % O₂. Preferably, the water-containing oxygen-containing stream provided in step (a) comprises at most 99 mol. % O₂, more preferably at most 98 mol % O₂.

Further, it is preferred that the water-containing oxygen-containing stream provided in step (a) comprises from 2.0 to 20 mol % H₂O, preferably from 3.0 mol % to 10.0 mol % H₂O.

The water-containing oxygen-containing stream provided in step (a) typically also comprises hydrogen (H₂). Preferably, the water-containing oxygen-containing stream provided in step (a) comprises from 0.3 to 2.0 mol % H₂.

Preferably, the water-containing oxygen-containing stream provided in step (a) has a pressure of from 0.1 bara to 2.5 bara, preferably from 0.5 bara to 1.5 bara.

The pressure of the water-containing oxygen-containing stream provided in step (a) may be referred to as ‘first pressure’.

Further it is preferred that the water-containing oxygen-containing stream provided in step (a) has a temperature of from 20 to 90 °C, preferably from 40 to 80 °C.

If appropriate, the water-containing oxygen-containing stream provided in step (a) may have been pre-processed to obtain the desired composition and conditions.

In step (b) of the method according to the present invention, the water-containing oxygen-containing stream provided in step (a) is combined as a suction fluid in an ejector with a water-containing stream as a motive fluid, thereby obtaining a combined stream.

As ejectors are known in the art, these are not further described here in detail. Ejectors have for example been described in Perry's Chemical Engineers' Handbook, 6th edition, 1985, pages 5-21 to 5-22 and 6-31 to 6-33. Ejectors are considered static equipment and are generally associated with low capital and operating costs in comparison to compressors.

Preferably, the motive fluid in step (b) comprises at least 80 mol % H₂O, preferably at least 90 mol %, more preferably at least 95 mol %. Typically, the motive fluid in step (b) comprises at most 99 mol % H₂O. The motive fluid in step (b) may also contain some O₂ and H₂. Typically, the motive fluid contains <0.5 mol. % O₂.

The person skilled in the art will readily understand that the pressure of the ‘motive fluid’ is higher than the pressure of the ‘suction fluid’ as used in the ejector. Preferably, the pressure of the motive fluid is at least 10 bar higher than the suction fluid, preferably at least 20 bar higher, more preferably at least 50 bar higher, even more preferably at least 80 bar higher.

Preferably, the motive fluid in step (b) has a pressure in the range of from 60 to 300 bara, preferably from 80 bara to 200 bara. Further it is preferred that the motive fluid in step (b) has a temperature of from 20 to 70 °C, preferably from 30 to 50 °C.

As already mentioned above, the (water-containing oxygen-containing stream to be used as the) suction fluid has a pressure of from 0.1 bara to 2.5 bara, preferably from 0.5 bara to 1.5 bara.

In step (c) of the method according to the present invention, the combined stream is flashed by the ejector, thereby obtaining a two-phase fluid discharged from the ejector. Typically, the flashing takes place in the throat of the ejector, thereby obtaining the two-phase fluid whilst leaving the ejector.

As a consequence of the flashing, the pressure of the combined stream is reduced. Preferably, the two-phase fluid obtained in step (c) has a pressure of from 2.0 bara to 10.0 bara, preferably from 3.0 bara to 6.0 bara. The pressure of the two-phase fluid obtained in step (c) may be referred to as ‘second pressure’. This second pressure is higher than the ‘first pressure’ (of the water-containing oxygen-containing stream provided in step (a)).

In step (d) of the method according to the present invention, the two-phase fluid discharged from the ejector is separated into an oxygen-containing gas stream and a liquid stream.

This separation in step (d) is not particularly limited and typically takes place in a conventional gas/liquid-separator.

The oxygen-containing gas stream obtained in step (d) (which is at the increased, second pressure) will be further processed (e.g. dehydrogenated, dehydrated and further compressed) and used as a product, for example in a gasifier.

In step (e) of the method according to the present invention, the liquid stream obtained in step (d) is pressurized, thereby obtaining a pressurized liquid stream. The person skilled in the art will readily understand that this pressurizing may be performed in many ways, e.g. by using a pump, in order to obtain the desired pressure for use as the motive fluid.

In step (f) of the method according to the present invention, the pressurized liquid stream obtained in step (e) is used as the motive fluid in step (b).

In step (g) of the method according to the present invention, the oxygen-containing gas stream obtained in step (d) is dehydrogenated, thereby obtaining a dehydrogenated oxygen-containing stream. As the person skilled in the art is familiar with dehydrogenation, this is not discussed here in detail. The dehydrogenation can be done by for example catalytic H₂/O₂ combustion. If such catalytic H₂/O₂ combustion is used, then reactor temperatures are in the range of 70 to 150 °C.

The dehydrogenated oxygen-containing stream preferably has a H₂ content of less than 1 mol %, preferably less than 10 ppm, more preferably less than 5 ppm.

In step (h) of the method according to the present invention, the dehydrogenated oxygen-containing stream obtained in step (g) is dehydrated, thereby obtaining a dehydrated dehydrogenated oxygen-containing stream. As the person skilled in the art is familiar with dehydration, this is not discussed here in detail. Typically, the dehydrated dehydrogenated oxygen-containing stream comprises less than 10 ppm H₂O.

In step (i) of the method according to the present invention, the dehydrated dehydrogenated oxygen-containing stream obtained in step (h) is compressed, thereby obtaining a compressed oxygen-containing stream. Typically, the compressed oxygen-containing stream has a pressure in the range of 6 to 70 bara, preferably 30 to 60 bara.

In step (j) of the method according to the present invention, the compressed oxygen-containing stream obtained in step (i) is used, in particular in a gasifier. As a person skilled in the art is familiar with a gasifier, this is not further discussed here in detail. Suitable gasifiers have for example been disclosed in WO 2017/102942 A1. Typically, the gasifier forms part of syngas and fossil-based hydrogen production line-ups and the like.

The person skilled in the art will readily understand that the method according to the present invention may comprise further steps. As an example, some cooling may be performed on the liquid stream obtained in step (d) and/or the pressurized liquid stream obtained in step (e), in order to obtain the desired temperature or the motive fluid to be used in step (b). As the person skilled in the art is familiar with cooling, this is not discussed here in detail. The cooling can for example take place by means of a heat exchanger, e.g. using air or another medium.

In a further aspect, the present invention provides an apparatus for compressing a water-containing, in particular a water-saturated, oxygen-containing stream originating from an electrolyzer, the apparatus at least comprising:
an electrolyzer for electrolyzing a water-containing stream, thereby obtaining at least a (water-containing, in particular water-saturated) H₂-containing stream and a water-containing (in particular water-saturated) oxygen-containing stream;
an ejector for combining the water-containing oxygen-containing stream as a suction fluid with a water-containing stream as a motive fluid, thereby obtaining a combined stream and flashing the combined stream, thereby obtaining a two-phase fluid discharged from the ejector;
a separator for separating the two-phase fluid discharged from the ejector into an oxygen-containing gas stream and a liquid stream;
a pressure increaser, in particular a pump, for pressurizing the liquid stream, thereby obtaining a pressurized liquid stream; and
a recycle line for recycling at least a part of the pressurized liquid stream to be used as the motive fluid in the ejector;
a dehydrogenator for dehydrogenating the oxygen-containing gas stream, thereby obtaining a dehydrogenated oxygen-containing stream;
a dehydrator for dehydrating the dehydrogenated oxygen-containing stream, thereby obtaining a dehydrated dehydrogenated oxygen-containing stream;
at least one compressor for compressing the dehydrated dehydrogenated oxygen-containing stream, thereby obtaining a compressed oxygen-containing stream; and
a gasifier, in which the compressed oxygen-containing stream is used.

A bleed or make-up of water may be present as well for the recycle line (to remove or add water if needed). Hereinafter the present invention will be further illustrated by the following non-limiting drawings. Herein shows:

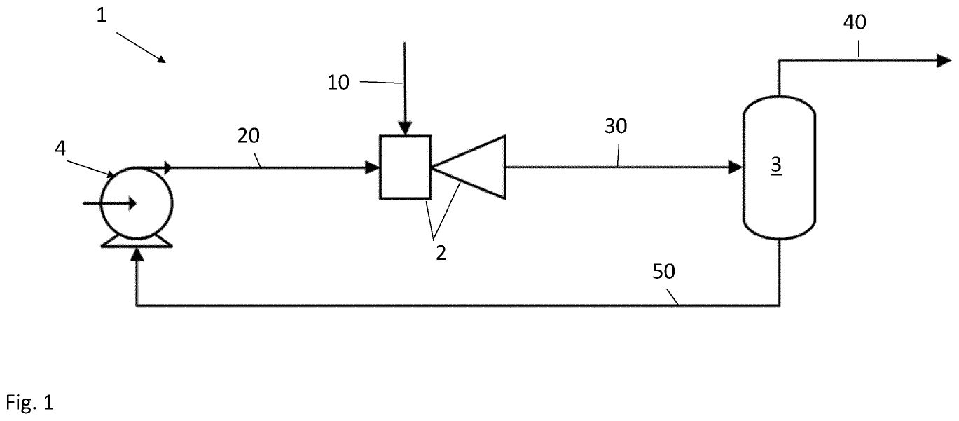

FIG. 1 schematically a flow scheme of part of the method for compressing a water-saturated oxygen-containing stream originating from an electrolyzer according to the present invention;

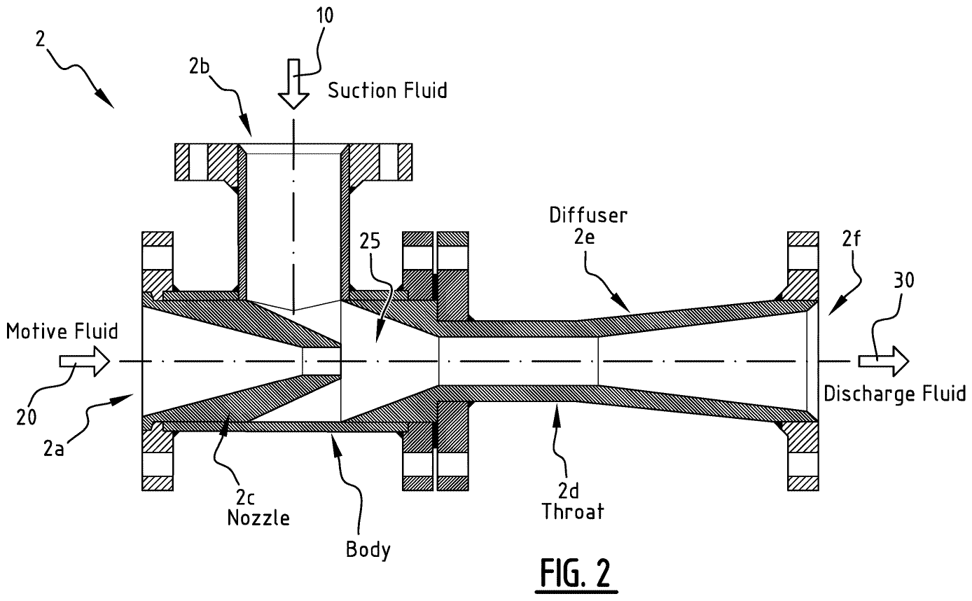

FIG. 2 schematically a detailed view of an exemplary, non-limiting embodiment of an ejector that can be used in the method according to the present invention;

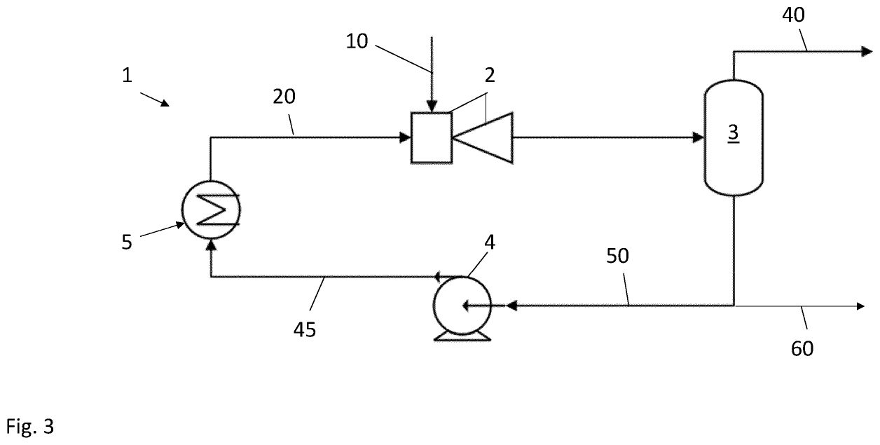

FIG. 3 schematically an alternative embodiment of part of the method according to the present invention, further containing a cooler downstream of the pump 4 in FIG. 1;

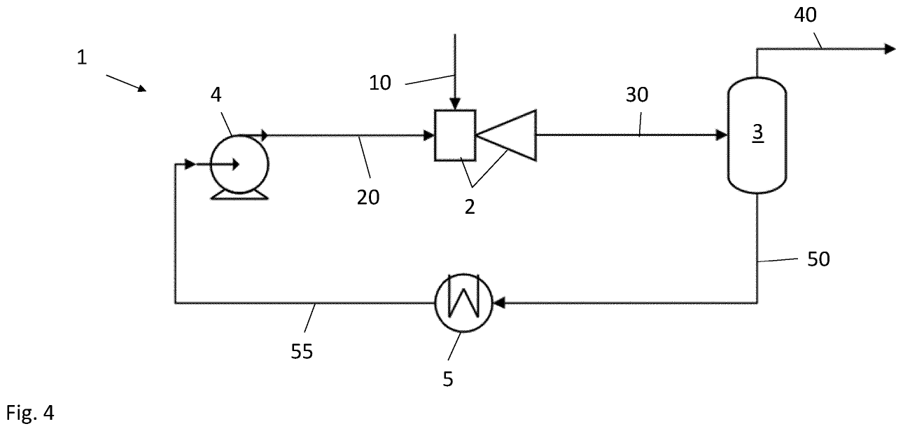

FIG. 4 schematically an alternative embodiment of the method according to the present invention, further containing a cooler upstream of the pump 4 in FIG. 1; and

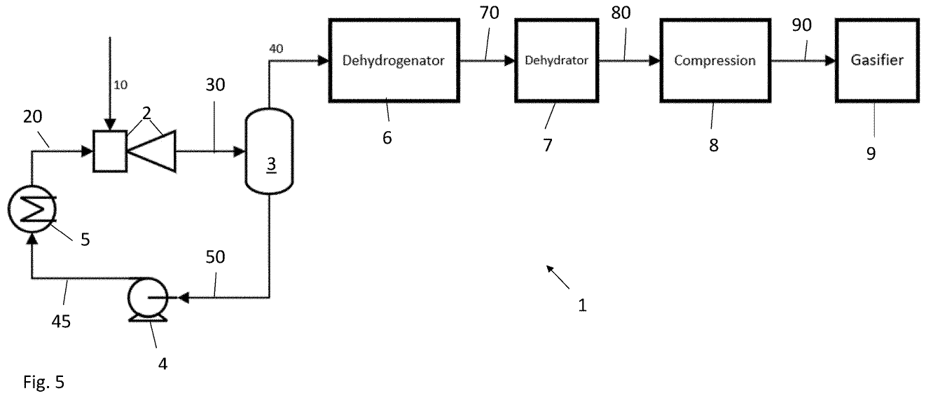

FIG. 5 schematically an exemplary method according to the present invention (based on FIG. 3) also showing a dehydrogenator, a dehydrator, a compressor, and a gasifier.

For the purpose of this description, same reference numbers refer to same or similar components.

The flow scheme of FIG. 1 generally referred to with reference number 1, shows an ejector 2, a gas/liquid-separator 3 and a pump 4. Preferably, one of the inlets (‘2b’ in FIG. 2) of the ejector 2 is connected with an outlet of an electrolyzer (not shown) for the water-saturated oxygen-containing stream 10 to be used in the ejector 2. Of course, there may be a g/l-separator and/or cooler between the outlet of the electrolyzer and the inlet (2b in FIG. 2) of the ejector 2.

During use of the flow scheme of FIG. 1, a water-saturated oxygen-containing stream 10 is combined as a suction fluid in the ejector 2 with a water-containing stream 20 as a motive fluid, thereby obtaining a combined stream. The combined stream is flashed by the ejector 2, thereby obtaining a two-phase fluid 30 discharged from the ejector 2.

A more detailed view of (a non-limiting embodiment of) the ejector 2 is shown in FIG. 2 and is discussed hereafter. In the ejector 2, the water-saturated oxygen-containing stream 10 is combined as a suction fluid with a motive fluid 20, thereby obtaining a combined stream (not shown in FIG. 1; ‘25’ in FIG. 2). The combined stream is flashed by the ejector 2 whilst leaving the ejector 2, thereby obtaining a two-phase fluid 30 discharged from the ejector 2.

The two-phase fluid 30 discharged from the ejector 2 is separated in a conventional gas/liquid-separator 3 into an oxygen-containing gas stream 40 and a liquid stream 50. Part of the liquid stream 50 may be used as a bleed stream (not shown in FIG. 1; cf. stream 60 in FIG. 3).

The oxygen-containing gas 40 (which has an increased pressure when compared to the water-saturated oxygen-containing stream 10) may be routed to further compression and purification (e.g. dehydrogenation, dehydration, . . . ) prior to end use, e.g. in a gasifier (see also FIG. 5 hereafter).

The liquid stream 50 coming from the gas/liquid-separator 3 is pressurized in the pump 4, thereby obtaining a pressurized liquid stream, which is used as the motive fluid 20 in the ejector 2.

FIG. 2 shows a more detailed view of an ejector that can be used as the ejector 2 in FIG. 1.

As can be seen from FIG. 2, the ejector 2 comprises an inlet 2a for the motive fluid 20, an inlet 2b for the suction fluid 10, a nozzle 2c within the ejector 2 for the motive fluid, a throat 2d with a diffuser section 2e and an outlet 2f for the fluid 30 to be discharged.

The motive fluid 20 and suction fluid 10 are combined in the ejector 2 (just after nozzle 2c) to form a combined stream 25. The combined stream 25 is then flashed by (the throat 2d of) the ejector 2, thereby obtaining a two-phase fluid 30 discharged from the (outlet 2f of the) ejector 2.

FIGS. 3 and 4 schematically show alternative embodiments of the method according to the present invention, wherein a cooler 5 is used downstream (FIG. 3) or upstream (FIG. 4) of the pump 4 in FIG. 1. It goes without saying, that also a cooler may be present both downstream and upstream of the pump 4. In the embodiments of FIGS. 3 and 4, the cooler 5 is in the form of an indirect heat exchanger.

In the embodiment of FIG. 3, the cooler 5 cools the pressurized liquid stream (referred to as ‘45’ in FIG. 3) exiting the pump 4; the cooled pressurized liquid stream coming from the cooler 5 is subsequently used as the motive stream 20 in the ejector 2. Further, FIG. 3 shows the presence of a bleed stream 60.

In the embodiment of FIG. 4, the cooler 5 cools the liquid stream 50 obtained in the gas/liquid-separator 3, which cooled liquid stream is then passed as stream 55′ to the pump 4.

FIG. 5 provides a fuller overview of the flow scheme of the method according to the present invention (based on the embodiment of FIG. 3), also showing a dehydrogenator 6, a dehydrator 7, a compressor 8, and a gasifier 9.

During use of the flow scheme of FIG. 5, the oxygen-containing gas stream 40 is dehydrogenated in dehydrogenator 6, thereby obtaining a dehydrogenated oxygen-containing stream 70.

This dehydrogenated oxygen-containing stream 70 is subsequently dehydrated in dehydrator 7, thereby obtaining a dehydrated dehydrogenated oxygen-containing stream 80 which is compressed in one or more compressors 8 thereby obtaining a compressed oxygen-containing stream 90.

The compressed oxygen-containing stream 90 can be used, in particular in a gasifier 9.

### EXAMPLES

### Example 1

The flow scheme of FIG. 3 was used for illustrating the compressing of a gaseous water-saturated oxygen-containing stream originating from an electrolyzer. The compositions and conditions of the fluid (i.e. gas and liquid) streams in the various flow lines are provided in Table 1 below.

In the ejector 2, the P_{suction} was 1.1 bara, whilst the P_{discharge} was 6.0 bara.

TABLE 1

| | Fluid stream | | | | | | |
|---|---|---|---|---|---|---|---|
| | 10 | 20 | 30 | 40 | 45 | 50 | 60 |
| | Phase | | | | | | |
| | V | L | V/L | V | L | L | L |
| T [°C] | 40.00 | 40.00 | 41.89 | 41.89 | 43.06 | 41.89 | 41.89 |
| p [bar a] | 1.10 | 81.00 | 5.98 | 5.98 | 81.5 | 5.98 | 5.98 |
| O₂ [kg/s] | 14.16 | 0.20 | 14.37 | 14.16 | 0.2 | 0.2 | 1.00 × 10⁻⁴ |
| H₂O [kg/s] | 0.48 | 704.17 | 704.65 | 0.112 | 704.17 | 704.17 | 0.37 |
| H₂ [kg/s] | 2.80 × 10⁻³ | 9.87 × 10⁻⁶ | 2.80 × 10⁻³ | 0.0028 | 9.87 × 10⁻⁶ | 9.87 × 10⁻⁶ | 5.20 × 10⁻⁹ |
| O₂ [mol. %] | 94.00 | 0.02 | 1.10 | 98.31 | 0.02 | 0.02 | 0.02 |
| H₂O [mol. %] | 5.70 | 99.98 | 98.80 | 1.38 | 99.98 | 99.98 | 99.98 |
| H₂ [mol. %] | 0.30 | 1.26 × 10⁻⁵ | 3.60 × 10⁻³ | 0.31 | 1.26 × 10⁻⁵ | 1.26 × 10⁻⁵ | 1.26 × 10⁻⁵ |

### DISCUSSION

As can be seen from Table 1, the process according to the present invention allows for an effective way of compressing a water-saturated oxygen-containing stream originating from an electrolyzer.

An important advantage of the present invention is that by using the water-saturated oxygen-containing stream as a suction fluid in an ejector, a pressurized oxygen-containing gas stream can be obtained in a surprisingly simple manner, without the safety issues as confronted in ‘dry compression’. The pressurized oxygen-containing gas stream can subsequently be used in a gasifier.

The person skilled in the art will readily understand that many modifications may be made without departing from the scope of the invention. Further, the person skilled in the art will readily understand that, while the present invention in some instances may have been illustrated making reference to a specific combination of features and measures, many of those features and measures are functionally independent from other features and measures given in the respective embodiment(s) such that they can be equally or similarly applied independently in other embodiments.

1. A method of compressing a water-containing oxygen-containing stream originating from an electrolyzer, the method at least includes:
(a) providing a water-containing oxygen-containing stream (10) originating from an electrolyzer;
(b) combining the stream (10) as a suction fluid in an ejector (2) with a water-containing stream (20) as a motive fluid, obtaining a combined stream;
(c) flashing the combined stream obtaining a two-phase fluid (30) discharged from the ejector (2);
(d) separating the two-phase fluid (30) into an oxygen-containing gas stream (40) and a liquid stream (50);
(e) pressurizing the liquid stream (50) obtained in step (d), thereby obtaining a pressurized liquid stream;
(f) using the pressurized liquid stream obtained in step (e) as the motive fluid (20) in step (b);
(g) dehydrogenating the oxygen-containing gas stream (40) obtained in step (d), thereby obtaining a dehydrogenated oxygen-containing stream (70);
(h) dehydrating the dehydrogenated oxygen-containing stream (70) obtained in step (g), thereby obtaining a dehydrated dehydrogenated oxygen-containing stream (80);
(i) compressing the dehydrated dehydrogenated oxygen-containing stream (80) obtained in step (h) thereby obtaining a compressed oxygen-containing stream (90); and
(j) using the compressed oxygen-containing stream (90) obtained in step (i) in a gasifier (9).

2. The method according to claim 1, wherein the water-containing oxygen-containing stream (10) provided in step (a) comprises at least 80 mol % O₂.

3. The method according to claim 1, wherein the water-containing oxygen-containing stream (10) provided in step (a) comprises from 2.0 to 20 mol % H₂O.

4. The method according to claim 1, wherein the water-containing oxygen-containing stream (10) provided in step (a) comprises from 0.3 to 2.0 mol % H₂.

5. The method according to claim 1, wherein the water-containing oxygen-containing stream (10) provided in step (a) has a pressure of from 0.1 bara to 2.5 bara.

6. The method according to claim 1, wherein the water-containing oxygen-containing stream (10) provided in step (a) has a temperature of from 20 to 90 °C.

7. The method according to claim 1, wherein the motive fluid (20) in step (b) comprises at least 80 mol % H₂O.

8. The method according to claim 1, wherein the motive fluid (20) in step (b) has a pressure in the range of from 60 to 300 bara.

9. The method according to claim 1, wherein the motive fluid (20) in step (b) has a temperature of from 20 to 70 °C.

10. The method according to claim 1, wherein the two-phase fluid (30) obtained in step (c) has a pressure of from 2.0 bara to 10.0 bara.

11. An apparatus (1) for compressing a water-containing oxygen-containing stream (10) originating from an electrolyzer, the apparatus (1) at least comprising:
an electrolyzer for electrolyzing a water-containing stream, thereby obtaining at least a H₂-containing stream and a water-containing oxygen-containing stream (10);
an ejector (2) for combining the water-containing oxygen-containing stream (10) as a suction fluid with a water-containing stream (20) as a motive fluid, thereby obtaining a combined stream (25) and flashing the combined stream (25), thereby obtaining a two-phase fluid (30) discharged from the ejector (2);
a separator (3) for separating the two-phase fluid (30) discharged from the ejector (2) into an oxygen-containing gas stream (40) and a liquid stream (50);
a pressure increaser (4), in particular a pump, for pressurizing the liquid stream (50), thereby obtaining a pressurized liquid stream;
a recycle line for recycling at least a part of the pressurized liquid stream to be used as the motive fluid (20) in the ejector (2);
a dehydrogenator (6) for dehydrogenating the oxygen-containing gas stream (40), thereby obtaining a dehydrogenated oxygen-containing stream (70);
a dehydrator (7) for dehydrating the dehydrogenated oxygen-containing stream (70), thereby obtaining a dehydrated dehydrogenated oxygen-containing stream (80);
at least one compressor (8) for compressing the dehydrated dehydrogenated oxygen-containing stream (80), thereby obtaining a compressed oxygen-containing stream (90); and
a gasifier (9), in which the compressed oxygen-containing stream (90) is used.
